(19) United States
(12) Patent Application Publication
(10) Pub. No.: US 2024/0184225 A1
(43) Pub. Date: Jun. 6, 2024

(54) TONER

(71) Applicant: CANON KABUSHIKI KAISHA, Tokyo (JP)

(72) Inventors: TOHRU HIRAMATSU, Shizuoka (JP); KAZUYUKI SATO, Kanagawa (JP); ATSUHIKO OHMORI, Kanagawa (JP); TOMOHISA SANO, Shizuoka (JP); HIROKI KAGAWA, Shizuoka (JP); KOSUKE FUKUDOME, Tokyo (JP)

(21) Appl. No.: 18/516,690

(22) Filed: Nov. 21, 2023

(30) Foreign Application Priority Data
Nov. 28, 2022 (JP) 2022-189149

(51) Int. Cl. G03G 9/09

(52) U.S. Cl. CPC G03G 9/0902

(57) ABSTRACT

A toner contains toner particles containing a binder resin, and inorganic fine particles is provided. The toner particles exhibit a peak derived from boric acid when subjected to ATR-IR spectroscopy using germanium as the ATR crystal. The inorganic fine particles include inorganic fine particles A made of a nitride of a group 13 element of the periodic table, and the inorganic fine particles A have a hexagonal crystal structure in X-ray diffraction analysis.

### BACKGROUND

### Field

The present disclosure relates to a toner used in electrophotography and electrostatic recording and toner jet recording methods (hereinafter simply referred to as a “toner”).

### Description of the Related Art

Full-color image forming apparatuses such as full-color copiers and full-color printers require that the toner has much higher durability to print more sheets than ever.

Recently, an approach to providing excellent durability has been proposed in which plat particles with high volume resistivity, low dielectric constant, and high lubricity, such as boron nitride particles, are externally added to toner to maintain and improve the transferability of the toner (Japanese Patent Laid-Open No. 2011-128406).

However, boron nitride particles are difficult to keep adhering to the surfaces of toner particles due to their high lubricity and likely to separate from the surfaces of the toner particles, resulting in the issue of the toner not to maintain the transferability over a long period.

From the viewpoint of improving the adhesion of boron nitride particles to toner particles, a technique has been proposed in which boron nitride particles are externally added while being heated so that Ca or other metal ions in the boron nitride particles can crosslink to the ester of the binder resin in the toner particles to prevent boron nitride from burying in or separating from toner particles (Japanese Patent Laid-Open No. 2015-125413).

Unfortunately, the metal ions in the boron nitride particles disclosed in Japanese Patent Laid-Open No. 2015-125413 are ion-bonded to the functional groups such as OH groups at the ends of the boron nitride particles. Since the reaction of the boron nitride with the binder resin of the toner arises at the ends of the boron nitride flat particles, the separation of boron nitride particles from toner particles is not sufficiently solved in electrophotographic processes including development and transfer.

If boron nitride particles separate from toner particles, the toner is not sufficiently transferred from the electrostatic latent image bearing member because the toner is poor in lubricity compared to boron nitride particles, which have smoothness and chemical stability resulting in high lubricity. Also, binding with metal ions reduces volume resistivity, degrading chargeability. Consequently, in long-life machines that can print a larger number of sheets, image density can decrease, or fogging can worsen.

Thus, no toner that can maintain transferability for a long period and maintain a high charge quantity has not yet been embodied.

### SUMMARY

The present disclosure provides a toner that is stable in transfer, is improved in the amount of charge, and can consistently form high-quality electrophotographic images even when used in long-life machines.

Accordingly, a toner containing toner particles containing a binder resin, and inorganic fine particles is provided. When subjected to ATR-IR (Attenuated Total Reflection Infrared) Spectroscopy using germanium as the ATR crystal, the toner particles exhibit a peak derived from boric acid. The inorganic fine particles include inorganic fine particles A made of a nitride of a group 13 element of the periodic table, and the inorganic fine particles A have a hexagonal crystal structure in X-ray diffraction analysis.

Further features of the present disclosure will become apparent from the following description of exemplary embodiments.

### DESCRIPTION OF THE EMBODIMENTS

Some embodiments of the present disclosure will now be described.

### Features of the Present Disclosure

A boron nitride particle has a hexagonal crystal structure in which hexagonal lattices defined by B—N bonds formed of boron and nitrogen atoms are laid one on another. Since the (0001) plane of the boron nitride particle, which defines the hexagonal lattice, is chemically very stable, boron nitride particles are known to have superior lubricity to other substances.

The (0001) plane of boron nitride particle is highly lubricious, that is, less adhesive, to the surfaces of the toner particles. Accordingly, boron nitride particles are likely to separate from the toner surface in electrophotographic printing processes and, particularly in long-life printing machines, the toner cannot maintain its good transferability, resulting in decreased image density, or separated boron nitride particles adversely affect images.

The present inventors identified that externally adding hexagonal inorganic particles A made of a nitride of a group 13 element in the periodic table to toner particles containing a boric acid component in the vicinity of their surfaces extraordinarily improves the transferability and chargeability while enhancing the adhesion of the inorganic fine particles A to the toner particles.

The present inventors believe the reason why the transferability and chargeability are improved is as described below:

The boric acid in the toner particles is probably broken during the toner production by binding to the OH groups of the resin component contained in the toner particles and is then condensed, thus being present as metaborate ions BO₂⁻. When borate ions are moderately present, the borate ion component is probably partially in a metaborate form, taking a structure close to a pseudo-hexagonal lattice structure. When the (0001) planes of the boron nitride particles that are a constituent of the inorganic fine particles A come into contact with such borate ions present in the vicinity of the surfaces of toner particles, probably, a strong interaction occurs between the hexagonal lattices defined by B—N bonds in the boron nitride particles and borate ions in the vicinity of the surfaces of toner particles to exhibit a strong adhesion between the chemically stable (0001) planes of boron nitride particles and the toner surfaces.

This interaction between the boric acid component present in the vicinity of the toner surface and boron nitride particles enables the boron nitride particles to be kept adhering firmly to the toner surface, reducing the likelihood that the boron nitride particles separate from the surfaces of toner particles to maintain the transferability. This is probably the reason why the service life of the toner is increased.

When the boric acid component is present in the vicinity of the surfaces of toner particles, the boron nitride particles are secured by the interaction with the boric acid component at the surfaces of the toner particles, becoming difficult to separate. In addition, the boric acid component crosslinks the binder resin in the toner particles to increase the viscoelasticity of the surfaces of the toner particles. Consequently, the boron nitride particles are less likely to be buried in the toner particles even after a long enduring. In other words, even after the toner is used for a long period under severe printing conditions (see “Examinations” in Examples, described later, for specifics), the high transferability and chargeability of the toner can be maintained.

Inorganic fine particles A may include aluminum nitride particles (in the wurtzite structure) and gallium nitride particles (in the wurtzite structure). Such nitrides of group 13 elements of the periodic table having a hexagonal crystal structure like boron nitride particles can interact with the boric acid component in the vicinity of the surface of the toner particles to enhance the adhesion to the toner surface.

The high adhesion of inorganic fine particles A to toner maintains the lubricity of the toner and improves the transferability of the toner from electrostatic latent image bearing members to media or the like and the chargeability of the toner.

This is because the combined use of the boric acid component present in the vicinity of the surfaces of the toner particles disclosed herein and inorganic fine particles A maintains and enhances the adhesion of inorganic fine particles A to the surfaces of the toner particles, thereby providing stable transferability and maintaining high charge quantity even after long-period use.

The present inventors believe that, thus, inorganic fine particles A become less likely to separate from the toner surface even when the toner is used in long-life machines and that the toner can maintain both the transferability from the electrostatic latent image bearing members or the like and keep the chargeability high to consistently form high-quality electrophotographic images. This effect can only be produced by allowing inorganic fine particles A to coexist with the boric acid present in the vicinity of the surfaces of the toner particles.

The present disclosure will now be described in more detail.

### Inorganic Fine Particles A

Inorganic fine particles A used in the toner disclosed herein will first be described.

Hexagonal crystalline inorganic fine particles A used herein may have a number average primary particle size of 300 nm to 2000 nm, and the D/T ratio of individual inorganic fine particles A, the ratio of the longer diameter D (nm) to the thickness T (nm), may be in the range of 3.0 to 55.0.

Such inorganic fine particles A are plate-like, large-diameter flat particles, and the wide areas of the plate-like flat surfaces of inorganic fine particles A adhere to the surfaces of the toner particles. The boric acid component, which is present in the surfaces of the toner particles, interacts with inorganic fine particles A to enhance the adhesion to the toner particles of even external additives having large diameters. Boron nitride particles, a constituent of inorganic fine particles A, having the article sizes mentioned above, are less likely to be buried in the toner and can act consistently as highly lubricious spacer particles to maintain transferability over a long period.

In some embodiments, the number average primary particle size of inorganic fine particles A is 500 nm to 1000 nm. Inorganic fine particles A with a number average primary particle size of 500 nm or more can act as spacers effectively to provide desired transferability. Also, inorganic fine particles A with a number average primary particle size of 1000 nm or less have sufficient areas to adhere to the toner particles to produce a strong effect of the interaction with the boric acid component, thus reducing the separation of inorganic fine particles A and providing stable transferability over a long period.

In some embodiments, also, the D/T ratio of individual inorganic fine particles A, the ratio of the longer diameter D (nm) to the thickness T (nm), is in the range of 6.0 to 20.0. When the D/T ratio is in this range, the plate-like flat surfaces of inorganic fine particles A can adhere to the surfaces of the toner particles and thus easily interact with the boric acid component in the vicinity of the surfaces of the toner particles to reduce the separation of inorganic fine particles A and provide stable transferability over a long period.

It will be described later how to measure the number average particle size, the longer diameter D, and the thickness T.

When inorganic fine particles A are hexagonal crystalline boron nitride particles, the graphitization index (GI) value of the boron nitride particles measured by powder X-ray diffractometry may be 1.60 to 35.0. The GI value, which was reported by J. Thomas et al. in J. Am. Chem. Soc. 24, 4619 (1962), can be obtained by calculating an integral intensity ratio, or area ratio, of the (100), (101), and (102) lines in the X-ray diffraction pattern using the following equation. The smaller the GI value, the higher the crystallinity.

GI value=[area{(100)+(101)}]/[area (102)],

wherein area {(100)+(101)} represents the sum of the peak area derived from the (100) plane and the peak area derived from the (101) plane, and area (102) represents the peak area derived from the (102) plane.

As mentioned above, the GI value is an index of the crystallinity of hexagonal crystalline boron nitride, and the higher the crystallinity, the smaller the GI value. The GI value of completely crystallized (graphitized) boron nitride is considered 1.60.

The boron nitride particles with a GI value of 1.60 to 35.0 can promote the interaction with the boric acid component in the vicinity of the surfaces of the toner particles, maintaining the adhesion of the boron nitride particles to maintain the transferability effectively.

If the GI value exceeds 35.0, the crystallinity of boron nitride decreases, and the lubricity is lost. Thus, the boron nitride particles cannot easily produce the effect of maintaining transferability. If the GI value is less than 1.60, the boron nitride is highly crystalline and difficult to interact with the boric acid component in the vicinity of the surfaces of the toner particles. The boron nitride particles are thus less likely to adhere sufficiently to the toner particles.

The amount of inorganic fine particles A added may be 0.01 part to 5.00 parts by mass relative to 100 parts by mass of the toner particles. In some embodiments, it is 0.10 part to 2.50 parts by mass.

Inorganic fine particles A in 0.01 part by mass or more are likely to exhibit the above-described effect. Also, when the amount of inorganic fine particles A is 5.00 parts by mass or less, inorganic fine particles A are less likely to separate, and defective images caused by separated inorganic fine particles A attaching to the developing member can be reduced.

Inorganic fine particles A may be boron nitride particles (in the hexagonal structure), aluminum nitride particles (in the wurtzite structure), or gallium nitride particles (in the wurtzite structure). In many embodiments, boron nitride particles are used.

Boron nitride particles may be produced by, for example, reductive nitridation of molten boric anhydride with ammonia. Basically, boron nitride particles are obtained according to the reaction formula:

B₂O₃+2NH₃→2BN+3H₂O

by reacting the raw material, such as boric acid, borates, or molten boric anhydride, with ammonia in a synthesis furnace for nitridation reduction, followed by purification and crystallization.

Boron oxide is softened to be glassy at around 450° C. and stops nitriding. Therefore, nitridation reduction is performed by adding urea, dicyanodiamide, ammonium chloride, or the like to boric acid and heating the materials.

The boron nitride particles produced in such a process contain O atoms as trace impurities. The amount of O atoms can be controlled by raw materials, the catalyst used for the reaction, the amount of catalyst, and reaction conditions. Also, the number average primary particle size of the boron nitride particles can be controlled by appropriately selecting the catalyst used for the reaction and reaction conditions or by pulverizing the produced boron nitride particles by a known wet pulverizer.

Inorganic fine particles A may contain oxygen atoms as impurities. When the oxygen content of inorganic fine particles A is 0.05% to 3.00% by mass, inorganic fine particles A can firmly interact with the boric acid component in the surfaces of the toner particles to keep adhering to the toner particles over a long period. Consequently, the lubricity of the toner is maintained, and thus, a toner keeping transferability and chargeability at high levels over a long period can be obtained.

In some embodiments, the oxygen content of inorganic fine particles A is 0.10% to 2.30% by mass.

When the toner disclosed herein is subjected to adhesion measurement using a polycarbonate thin film, the adhesion of inorganic fine particles A may be such that the amount of inorganic fine particles A adhering to the polycarbonate thin film is 0.50 area % or less to the entire area (100 area %) of the polycarbonate thin film.

Polycarbonate is conventionally and typically used as the material of the surface layer of the electrostatic latent image bearing member. The adhesion measurement using a polycarbonate thin film is an analytical method to quantify the amount of the external additive transferred, which is performed by applying specific vibration to the toner evenly put on the polycarbonate thin film to roll and drop the toner and observing the external additive, such as inorganic fine particles, remaining on the polycarbonate thin film. The adhesion measurement using polycarbonate thin films will be described in detail later.

This adhesion measurement using polycarbonate thin films can quantify the ease of transfer of inorganic fine particles when the fine particles on the surfaces of the toner particles are forcedly transferred from the toner. The inorganic fine particles transferred from the toner particles are observed by scanning electron microscopy (SEM), thereby determining the amount of inorganic fine particles transferred to the electrostatic latent image bearing member from the toner particles.

Alternatively, a general method may be applied to measure the amount of inorganic fine particles transferred from toner particles. More specifically, the toner in a surfactant aqueous solution or the like is stirred or shaken and subjected to centrifugation or the like to separate inorganic fine particles from the toner (this method is hereinafter referred to as the wet method).

The adhesion measurement using a polycarbonate thin film can suggest how easily inorganic fine particles are transferred to the polycarbonate thin film by transferring the inorganic fine particles from the toner particles without applying strong shear to the toner, as in the wet method. How easily inorganic particles are transferred indicates the adhesion strength of the inorganic fine particles to the toner particles. Hence, in the present disclosure, the amount of inorganic fine particles A adhering to the polycarbonate thin film indicates the strength of the adhesion of inorganic fine particles A to the toner particles and the ease of transfer, estimated from the adhesion strength, to the member (particularly the electrostatic latent image bearing member) that comes into contact with the toner.

When the amount of inorganic fine particles A attached to the polycarbonate thin film is 0.50% by area or less, inorganic fine particles A adhere firmly to the toner particles.

### Boric Acid

The boric acid used in the toner particles disclosed herein will now be described. Boric acid may be added to the toner particles in any manner without limitation. For example, boric acid may be added to the inside of the toner particles or added as an aggregating agent used in an aggregation method so as to be contained in the toner particles. Using boric acid as an aggregating agent facilitates the introduction of boric acid to the vicinity of the surfaces of the toner particles. Before use as a raw material, the boric acid may be in the form of organic boric acid compounds, boric acid salts, or boric acid esters. In some embodiments in which the toner particles are produced in an aqueous medium, a boric acid salt, such as sodium tetraborate or ammonium borate, is added, particularly borax, from the viewpoint of reactivity and production stability.

Borax, which is represented by the decahydrate of sodium tetraborate Na₂B₄O₇, turns into boric acid in acidic aqueous solutions and is therefore suitable when boric acid is used in an aqueous medium under acidic conditions.

When the toner particles are subjected to X-ray fluorescence analysis, the peak intensity of boron derived from boric acid may be 0.10 kcps to 0.60 kcps, for example, 0.10 kcps to 0.30 kcps. By controlling the boron peak intensity in such a range, the amount of boric acid in the vicinity of the surfaces of the toner particles can be so appropriate as inorganic fine particles A adhere firmly to the toner particles.

For controlling the boron peak intensity in the above ranges, for example, the amount of boric acid source added when the toner particles are produced may be controlled so that the boric acid content of the toner particles can be 0.1% to 10.0% by mass. In some embodiments, the boric acid content of the toner particles may be 0.4% to 5.0% by mass or 0.8% to 2.0% by mass.

Also, the amount of boric acid in the vicinity of the surfaces of the toner particles may be estimated by the ratio IB/IC of the peak intensity IB at 1380 cm⁻¹, derived from boric acid, to the peak intensity IC in the range of 1700 cm⁻¹ to 1750 cm⁻¹, derived from the carbonyl group in the binder resin in infrared absorption spectra. When the IB/IC ratio is in the range of 0.02 to 0.30, the amount of boric acid in the vicinity of the surfaces of the toner particles is so appropriate that inorganic fine particles A are likely to adhere firmly to the toner particles.

The constituents of the toner and the process for producing the toner will be further described in detail.

### Binder Resin

The toner particles contain a binder resin. In some embodiments, the binder resin accounts for 50% by mass or more of the total mass of the resin in the toner particles.

Examples of the binder resin include, but are not limited to, styrene-acrylic resin, epoxy resin, polyester resin, polyurethane resin, polyamide resin, cellulose resin, polyether resin, and mixtures or composite resins of these resins. For example, styrene-acrylic resin or polyester resin may be used because these resins are inexpensive, easily available, and superior in low-temperature fixability. In some embodiments, polyester resin is used.

Polyester resin can be synthesized by combining some selected from polyvalent carboxylic acids, polyols, hydroxycarboxylic acids, and the like, for example, by transesterification, polycondensation, or any other known method. In some embodiments, the polyester resin includes a polycondensate of dicarboxylic acids and diols.

A polyvalent carboxylic acid is a compound containing two or more carboxy groups in the molecule, and a dicarboxylic acid is one of such polyvalent carboxylic acids and contains two carboxy groups in the molecule.

Examples include oxalic acid, succinic acid, glutaric acid, maleic acid, adipic acid, B-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexa-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Examples of polyvalent carboxylic acids other than dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. Polyvalent carboxylic acids may be used individually or in combination.

A polyol is a compound containing two or more hydroxy groups in the molecule. A diol, which is a type of polyol, is a compound containing two hydroxy groups in the molecule.

Examples of diols include ethylene glycol, diethylene glycol, triethylene glycol, 1,2-propanediol, 1,3-propanediol, 1,4-butanediol, 1,5-propanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, butylene oxide, etc.) adducts of these bisphenols.

In some embodiments, alkylene glycols with 2 to 12 carbon atoms or bisphenol alkylene oxide adducts may be used, particularly a bisphenol alkylene oxide adduct or a combination of a bisphenol alkylene oxide adduct and an alkylene glycol with 2 to 12 carbon atoms. The bisphenol A alkylene oxide adduct may be a compound represented by the following formula (A):

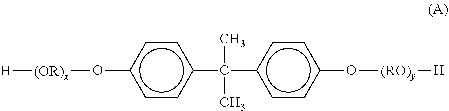

wherein R each independently represents an ethylene or a propylene group, x and y are each an integer of 0 or more, and the average of x+y is 0 to 10.

The bisphenol A alkylene oxide adduct may be bisphenol A propylene oxide adduct and/or bisphenol A ethylene oxide adduct. In some embodiments, it is a bisphenol A propylene oxide adduct. In some embodiments, the average of x+y is 1 to 5.

Examples of trihydric or higher alcohols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and trihydric or higher polyphenol alkylene oxide adducts. These polyols may be used individually or in combination.

Styrene-acrylic resin includes homopolymers of any one of the following polymerizable monomers, copolymers produced by combining two or more of the following monomers, or mixtures of such polymers.

Examples of polymerizable monomers include: styrene-based monomers, such as styrene, α-methylstyrene, β-methylstyrene, o-methylstyrene, m-methylstyrene, p-methylstyrene, 2,4-dimethylstyrene p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic monomers, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, and (meth)acrylic acid, and maleic acid;
vinyl ether monomers, such as vinyl methyl ether and vinyl isobutyl ether;
vinyl ketone monomers, such as vinyl methyl ketone, vinyl ethyl ketone, and vinyl isopropenyl ketone; and
polyolefins, such as ethylene, propylene, and butadiene.

The styrene-acrylic resin may be synthesized using polyfunctional polymerizable monomers, if necessary. Examples of polyfunctional polymerizable monomers include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, and divinyl ether.

A known chain transfer agent and polymerization inhibitor may be further added to control the polymerization degree.

Polymerization initiators used for producing the styrene-acrylic resin include organic peroxide initiators and azo polymerization initiators.

Organic peroxide initiators include benzoyl peroxide, lauroyl peroxide, di-a-cumyl peroxide, 2,5-dimethyl-2,5-bis(benzoylperoxy)hexane, bis(4-t-butylcyclohexyl) peroxydicarbonate, 1,1-bis(t-butylperoxy)cyclododecane, t-butylperoxymaleic acid, bis(t-butylperoxy) isophthalate, methyl ethyl ketone peroxide, tert-butylperoxy-2-ethylhexanoate, diisopropyl peroxycarbonate, cumene hydroperoxide, 2,4-dichlorobenzoyl peroxide, and tert-butyl peroxypivalate.

Azo initiators include 2,2′-azobis-(2,4-dimethylvaleronitrile), 2,2′-azobis(isobutyronitrile), 1,1′-azobis(cyclohexane-1-carbonitrile), 2,2′-azobis(4-methoxy-2,4-dimethylvaleronitrile), 2,2′-azobis(2-methylbutyronitrile), and 2,2′-azobis(methylisobutyrate).

Also, a redox initiator that is a combination of oxidizing and reducing substances may be used as the polymerization initiator.

Oxidizing substances include hydrogen peroxide, persulfates (sodium, potassium, and ammonium salts), inorganic peroxides, and oxidizing metal salts such as tetravalent cerium salts.

Reducing substances include reducing metal salts (divalent iron salts, monovalent copper salts, and trivalent chromium salts); amino compounds, such as ammonia, lower amines (methylamine, ethylamine, and other amines with about 1 to 6 carbon atoms), and hydroxylamine; reducing sulfur compounds, such as sodium thiosulfate, sodium hydrosulfate, sodium hydrogen sulfite, sodium sulfite, and sodium formaldehydesulfoxylate; lower alcohols (with 1 to 6 carbon atoms); ascorbic acid and its salts; and lower aldehydes (with 1 to 6 carbon atoms).

The polymerization initiator is selected with reference to the 10-hour half-life temperature and may be used alone or in a mixture. The amount of the polymerization initiator varies depending on the intended degree of polymerization, and in general, 0.5 parts to 20.0 parts by mass is added relative to 100.0 parts by mass of polymerizable monomers.

### Release Agent

The toner may contain a known wax as a release agent.

Examples of the wax include paraffin waxes, microcrystalline waxes, petroleum waxes and their derivatives, such as petrolatum, montan waxes and their derivatives, hydrocarbon waxes produced by the Fischer-Tropsch process and their derivatives, polyolefin waxes and their derivatives, such as polyethylene, and natural waxes and their derivatives, such as carnauba wax and candelilla wax. The derivatives include oxides, block copolymers with vinyl monomers, and graft-modified forms.

Other waxes may also be used, including higher aliphatic alcohols or the like; fatty acids such as stearic acid and palmitic acid and acid amides, esters, and ketones of those fatty acids; hydrogenated castor oil and its derivatives; plant waxes; and animal waxes. These waxes may be used individually or in combination.

In particular, polyolefin, hydrocarbon waxes produced by the Fischer-Tropsch process, and petroleum waxes tend to improve developability and transferability. An antioxidant may be added to the wax to the extent that the antioxidant does not affect the effects of the toner. In view of phase separation from the binder resin or crystallization temperature, a higher fatty acid ester, such as behenyl behenate or dibehenyl sebacate, may be used.

The amount of the release agent may be 1.0 to 30.0 parts by mass relative to 100.0 parts by mass of the binder resin.

The melting point of the release agent may be 30° C. to 120° C., for example, 60° C. to 100° C. The release agent having such thermal properties is efficient in releasing and ensures a wider fixing area.

### Plasticizer

The toner particles may contain a crystalline plasticizer to improve sharp melting characteristics. Any known plasticizer can be used in the toner without particular limitation, including the following:

Specific examples include esters of monovalent alcohols and aliphatic carboxylic acid or esters of monovalent carboxylic acids and aliphatic alcohols, such as behenyl behenate, stearyl stearate, and palmityl palmitate; dihydric alcohols and aliphatic carboxylic acids and divalent carboxylic acids and aliphatic alcohols, such as ethylene glycol distearate, dibehenyl sebacate, and hexanediol dibehenate; esters of trihydric alcohols and aliphatic carboxylic acids, such as glycerol tribehenat, and esters of trivalent carboxylic acids and aliphatic alcohols; esters of tetrahydric alcohols and liphatic carboxylic acids, such as such as pentaerythritol tetrastearate and pentaerythritol tetrapalmitate, and esters of tetravalent carboxylic acids and aliphatic alcohols; esters of hexahydric alcohols and aliphatic carboxylic acids, such as dipentaerythritol hexastearate and dipentaerythritol hexapalmitate, and esters of hexyavalent carboxylic acids and aliphatic alcohols; esters of higher polyhydric alcohols and aliphatic carboxylic acids, such as polyglycerol behenate, and esters of polycarboxilic acids and aliphatic alcohols; and natural ester waxes, such as carnauba wax and rice wax. These plasticizers may be used individually or in combination.

### Coloring Agent

The toner particles may contain a coloring agent. The coloring agent may be selected from known pigments and dyes. In an embodiment, pigment is used because of its high weatherability. Exemplary cyan coloring agents include copper phthalocyanine and their derivatives, anthraquinone compounds, and basic dye lakes.

Specific examples include C.I. Pigment Blues 1, 7, 15, 15:1, 15:2, 15:3, 15:4, 60, 62, and 66.

Exemplary magenta coloring agents include condensed azo compounds, diketopyrrolopyrrole compounds, anthraquinone compounds, quinacridone compounds, basic dye lakes, naphthol compounds, benzimidazolone compounds, thioindigo compounds, and perylene compounds.

Specific examples include C.I. Pigment Reds 2, 3, 5, 6, 7, 23, 48:2, 48:3, 48:4, 57:1, 81:1, 122, 144, 146, 150, 166, 169, 177, 184, 185, 202, 206, 220, 221, and 254 and C.I. Pigment Violet 19.

Exemplary yellow coloring agents include condensed azo compounds,

isoindolinone compounds, anthraquinone compounds, azo metal complexes, methine compounds, and allyl amide compounds.

Specific examples include C.I. Pigment Yellows 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

The black coloring agent may be prepared by mixing yellow, magenta, and cyan pigments to adjust to black, or carbon black may be used. Coloring agents may be used individually, in a mixture, or a solid solution.

The proportion of the coloring agent may be 1.0 to 20.0 parts by mass relative to 100.0 parts by mass of the binder resin.

### Charge Control Agent and Charge Control Resin

The toner particles may contain a charge control agent or charge control resin. Any known charge control agent may be used, particularly charge control agents exhibiting high triboelectric charge speed and keeping a triboelectric charge stable. In an embodiment of producing toner particles by suspension polymerization, charge control agents substantially insoluble in aqueous media and less likely to inhibit the polymerization may be used.

Charge control agents to control the toner in a negatively charged state include monoazo metal compounds; acetylacetone metal compounds; metal compounds of aromatic oxycarboxylic acids, aromatic dicarboxylic acids, oxycarboxylic or dicarboxylic acids; metal salts, anhydrides, and esters of oxycarboxylic, aromatic monocarboxylic or polycarboxylic acids; phenol derivatives such as bisphenol; urea derivatives; metal-containing salicylic acid-based compounds; metal-containing naphthoic acid-based compounds; boron compounds; quaternary ammonium salts; calixarene; and charge control resin.

The charge control resin may be a polymer or copolymer containing a sulfo group or a sulfonate group (in salt or ester). The polymer containing a sulfo or sulfonate group may be a copolymer containing 2% by mass or more, or 5% by mass or more in some embodiments, of sulfo group-containing acrylamide-based monomer or sulfo group-containing methacrylamide-based monomer.

In an embodiment, a charge control resin having a glass transition temperature (Tg) of 35° C. to 90° C., a peak molecular weight (Mp) of 10,000 to 30,000, and a weight average molecular weight (Mw) of 25,000 to 50,000 may be used. Such a charge control resin can impart proper triboelectric chargeability to the toner particles without affecting the thermal characteristics required for the toner. Additionally, the charge control resin containing sulfo groups can exhibit improved dispersibility in, for example, polymerizable monomer compositions or improve the dispersibility of the coloring agent, thus enhancing the coloring power, transparency, and triboelectric chargeability of the toner.

The charge control agent or charge control resin may be an individual substance or a combination of two or more substances. The amount of charge control agent or charge control resin may be 0.01 to 20.0 parts by mass, for example, 0.5 to 10.0 parts by mass, relative to 100.0 parts by mass of the binder resin.

### External Additive

The toner may contain any other external additive in addition to inorganic particles A. The toner may be produced by adding inorganic fine particles A and, optionally, other external additives. Such external additives include fine particles of silica, strontium titanate, hydrotalcite, fatty acid metal salt, alumina, titanium oxide, zinc oxide, cerium oxide, and calcium carbonate.

Composite oxide fine particles using two or more metals may also be used as external additives, or two or more of the above-cited external additives may be combined.

Resin fine particles or inorganic-organic combined fine particles containing resin fine particles and inorganic fine particles may be used. In some embodiments, the toner further contains titanium oxide particles as the external additive.

The titanium oxide particles may have shapes satisfying the following (i) and (ii):
(i) having a longer diameter of 300 nm to 3000 nm; and
(ii) having an aspect ratio of 5.0 or more.

The titanium oxide particles satisfying the above (i) and (ii), which have a rather large particle size and a low resistance as the external additive, have needle-like shapes. Such titanium oxide particles suppress overcharge and reduce changes in charge during long-period use.

The external additive other than inorganic fine particles A may be hydrophobized with a hydrophobization agent.

Examples of the hydrophobization agent include chlorosilanes, such as methyltrichlorosilane, dimethyldichlorosilane, trimethylchlororsilane, phenyltrichlorosilane, diphenyldichlorosilane, t-butyldimethylchlorosilane, and vinyltrichlorosilane;

alkoxysilanes, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl)aminopropylmethyldimethoxysilane;

silazanes, such as hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane; silicone oils, such as dimethyl silicone oil, methyl hydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminal-reactive silicone oil;

siloxanes, such as hexamethylcyclotrisiloxane, octamethylcyclotetrasiloxane, decamethylcyclopentasiloxane, hexamethyldisiloxane, and octamethyltrisiloxane; and fatty acids and their metal salts, including long-chain fatty acids, such as undecylic acid, lauric acid, tridecylic acid, myristic acid, palmitic acid, pentadecylic acid, stearic acid, heptadecylic acid, arachidic acid, montanic acid, oleic acid, linoleic acid, and arachidonic acid, and metals salts of these fatty acids and metals, such as zinc, iron, magnesium, aluminum, calcium, sodium, and lithium.

Alkoxysilanes, silazanes, and silicone oils can easily hydrophobize external additives and are accordingly used in some embodiments. The above-cited hydrophobization agents may be used individually or in combination.

The external additive content may be 0.05 to 20.0 parts by mass relative to 100 parts by mass of the toner particles. The amount of external additives other than inorganic fine particles A may be 0.1 to 10.0 parts by mass, for example, 0.5 to 7.0 parts by mass, relative to 100 parts by mass of the toner particles.

### Process for Producing the Toner

The toner may be produced by any process, including known methods, such as pulverization, suspension polymerization, dissolution suspension, emulsion aggregation, and dispersion polymerization, without particular limitation. In any of such methods for producing the toner particles, the boric acid source may be added when the raw materials are mixed. In an embodiment, the toner is produced by an emulsion aggregation method. The process for producing the toner by the emulsion aggregation method includes the following steps (1) to (3):
(1) dispersing binder resin fine particles containing a binder resin to prepare a dispersion liquid of the binder resin fine particles;
(2) aggregating the binder resin fine particles in the dispersion liquid to form aggregates of the binder resin fine particles; and
(3) heating the aggregates to fuse the aggregates.

The boric acid source is added in either step of (2) or (3).

The emulsion aggregation method in toner production can facilitate the shape control of the toner particles and the uniform dispersion of boric acid in the vicinity of the surfaces of the toner particles. The emulsion aggregation method will be described in detail below.

### Emulsion Aggregation Method

The emulsion aggregation method is a method for producing toner particles by previously preparing an aqueous dispersion liquid of fine particles of the toner constitution materials having considerably smaller particle size than the desired size, aggregating the fine particles in the aqueous dispersion liquid to enlarge to the particle size of the desired toner particles, and fusing the resin to form toner particles by heating or the like.

More specifically, in the emulsion aggregation method, toner particles are produced through the dispersion step of preparing a dispersion liquid of the constitution materials of toner particles, the aggregation step of aggregating the fine particles of the constitution materials to control the particle size to the size of the desired toner particles, and the fusing step of fusing the resin contained in the resulting aggregated particles, and further, the sphere forming step of melting the toner particles to control the surface profiles of the toner particles by heating or the like, a subsequent cooling step, the metal removal step of filtering the resulting toner to remove excess of polyvalent metal ions, the filtration and cleaning step of rinsing the toner particles with ion-exchanged water or the like, and the drying step of removing moisture to dry the rinsed toner particles.

### Preparing Resin Fine Particle Dispersion Liquid (Dispersion Step)

The resin fine particle dispersion liquid may be prepared by any of the known methods without particular limitation. Examples of the known methods include emulsion polymerization, self-emulsification, phase inversion emulsification in which the binder resin is emulsified by adding an aqueous medium to a solution of the resin in an organic solvent, and forced emulsification in which the binder resin is forcedly emulsified by high-temperature treatment in an aqueous medium without using organic solvents.

More specifically, the binder resin is dissolved in an organic solvent capable of dissolving the binder resin, and a surfactant and a basic compound are added to the binder resin solution. If the binder resin is a crystalline resin having a melting point, the resin can be dissolved by heating to the melting point or more. Subsequently, an aqueous medium is slowly added to the solution to precipitate resin fine particles while the solution is being stirred with a homogenizer or the like. Then, the solvent is removed by heating or reducing pressure to yield an aqueous dispersion liquid of the resin fine particles. Any solvent may be used to dissolve the resin, provided that it can dissolve the resin. In an embodiment, organic solvents, such as toluene, that can form a homogeneous phase with water are used from the viewpoint of reducing the formation of coarse particles.

Examples of the surfactant used for emulsification include, but are not limited to, anionic surfactants, such as sulfuric ester salt-based surfactants, sulfonate-based surfactants, carboxylate-based surfactants, phosphoric ester-based surfactants, and soap-based surfactants; cationic surfactants, such as amine salt surfactants and quaternary ammonium salt-based surfactants; and nonionic surfactants, such as polyethylene glycol-based surfactants, alkylphenol ethylene oxide adduct-based surfactants, and polyhydric alcohol-based surfactants. Such surfactants may be used individually or in combination.

Examples of the basic compound used in the dispersion step include inorganic bases, such as sodium hydroxide, potassium hydroxide, and ammonia; and organic bases, such as triethylamine, trimethylamine, dimethylaminoethanol, and diethylaminoethanol. Such basic compounds may be used individually or in combination.

The median diameter (D50) in the volume distribution of the binder resin fine particles in the resin fine particle aqueous dispersion liquid may be 0.05 μm to 1.0 um, for example, 0.05 μm to 0.4 μm. Controlling the volume distribution median diameter (D50) in such a range facilitates the production of the toner particles having an appropriated volume average particle size of 3.0 μm to 10.0 μm.

The volume distribution median diameter (D50) is measured with a dynamic light scattering particle size distribution analyzer Nanotrac UPA-EX150 (manufactured by Nikkiso Co., Ltd.)

### Coloring Agent Fine Particle Dispersion Liquid

A coloring agent fine particle dispersion liquid is optionally used. This dispersion liquid may be prepared by, but not limited to, the following known method.

The coloring agent fine particle dispersion liquid can be prepared by mixing a coloring agent, an aqueous medium, and a dispersant using a known mixing machine, such as a stirrer, an emulsifier, or a disperser. The dispersant may be selected from known surfactants, polymer dispersants, and other known substances.

Either surfactants or polymer dispersants can be removed by the cleaning step described later, but in some embodiments, surfactants are used from the viewpoint of cleaning efficiency.

Such surfactants include anionic surfactants, such as sulfuric ester salt-based surfactants, sulfonate-based surfactants, phosphoric ester-based surfactants, and soap-based surfactants; cationic surfactants, such as amine salt-based surfactants and quaternary ammonium salt-based surfactants; nonionic surfactants, such as polyethylene glycol-based surfactants, alkylphenol ethylene oxide adduct-based surfactants, and polyhydric alcohol-based surfactants.

In some embodiments, nonionic or anionic surfactants may be used. Nonionic and anionic surfactants may be used in combination. The surfactant may be an individual substance or a combination of two or more substances. The amount of the surfactant in the aqueous medium may be 0.5% to 5.0% by mass.

The amount of the coloring agent fine particles in the coloring agent fine particle dispersion liquid may be, but is not limited to, 1.0% to 30.0% by mass relative to the total mass of the coloring agent fine particle dispersion liquid.

The particle size of the coloring agent fine particles dispersed in the aqueous medium may be 0.5 μm or less in terms of volume distribution median diameter (D50) from the viewpoint of the dispersibility of the coloring agent in the finally obtained toner. For the same reason, D90, the particle size at 90% in a volume distribution, may be 2.0 μm or less. The particle size of the coloring agent fine particles dispersed in the aqueous medium is measured with a dynamic light scattering particle size distribution analyzer Nanotrac UPA-EX150 (manufactured by Nikkiso Co., Ltd.)

For dispersing the coloring agent in the aqueous medium, a known stirrer, emulsifier, disperser, or any other mixing device is used. Examples of such known mixing devices include ultrasonic homogenizers, jet mills, pressure homogenizers, colloid mills, ball mills, sand mills, and paint shakers. These devices may be used alone or in combination.

### Release agent (Aliphatic Hydrocarbon Compound) Fine Particle Dispersion Liquid

A release agent fine particle dispersion liquid may be used if necessary. The release agent fine particle dispersion liquid can be prepared by, but not limited to, the following known procedure.

A release agent is added to an aqueous medium containing a surfactant and dispersed as particles with a homogenizer that can apply high share force (for example, CLEARMIX W-MOTION manufactured by M Technique Co., Ltd.) or a pressure discharging disperser (for example, Gaulin Homogenizer, manufactured by Gaulin) while the mixture is being heated to a temperature equal to or higher than the melting point of the release agent. The resulting dispersion liquid is cooling to less than the melting point.

The median diameter (D50) in the volume distribution of the release agent fine particles dispersed in the aqueous medium may be 0.03 μm to 1.0 μm, for example, 0.1 μm to 0.5 μm. Desirably, no coarse particles of 1.0 μm or more are present in the dispersion liquid.

When the particle size of the particles dispersed in the release agent fine particle dispersion liquid is in such a range, the release agent can be so finely dispersed in the toner, consequently sufficiently seeping out to exhibit good releasing function during fixing. The particle size of the release agent fine particles dispersed in the aqueous medium can be measured with a dynamic light scattering particle size distribution analyzer Nanotrac UPA-EX150 (manufactured by Nikkiso Co., Ltd.)

### Mixing

In the mixing step, the resin fine particle dispersion liquid and at least either of the optional fine particle dispersion liquids, the release agent or coloring agent fine particle dispersion liquid, are mixed to prepare a mixture. The mixing step may be performed using a known mixing machine, such as a homogenizer or a mixer.

### Forming Aggregated Particles (Aggregation Step)

In the aggregation step, the fine particles in the mixture prepared in the mixing step are aggregated to form aggregates with an intended particle size. For this operation, an aggregating agent is added and mixed, and the resin fine particles and at least either the optional release agent or coloring agent fine particles are aggregated to form aggregates by, if necessary, at least either heating or mechanical power.

Examples of the aggregating agent include organic aggregating agents, such as quaternary ammonium salts and other cationic surfactants and polyethyleneimine; inorganic metal salts, such as sodium sulfate, sodium nitrate, sodium chloride, calcium chloride, and calcium nitrate; inorganic ammonium salts, such as ammonium sulfate, ammonium chloride, and ammonium nitrate; and other inorganic aggregating agents including divalent or higher valent metal complexes. For soft aggregation, an acid, such as sulfuric acid or nitric acid, may be added to reduce the pH.

The aggregating agent to be added may be in dry powder or dissolved in an aqueous medium as a solution. To uniformly aggregate the particles, an aggregating agent solution may be added. In some embodiments, the aggregating agent is added and mixed at a temperature lower than or equal to the glass transition temperature or melting point of the resin in the mixture. Mixing the aggregating agent at such a temperature enables the aggregation to proceed relatively uniformly. For mixing the aggregating agent into the mixture, a known mixing machine, such as a homogenizer or a mixer, may be used. The aggregation step is intended to form aggregates with a particle size equivalent to the toner particles in an aqueous medium. The aggregates formed in the aggregation step may have a volume average particle size of 3.0 μm to 10.0 μm. The volume average particle size can be measured by the Coulter counter method using a particle size distribution analyzer Coulter Multisizer III, manufactured by Beckman Coulter, Inc.

### Obtaining Toner Particles Contained in Dispersion Liquid (Fusing Step)

In the fusing step, first, aggregation in the dispersion liquid containing aggregates formed in the aggregating step is stopped under the same stirring conditions as in the aggregating step. More specifically, the aggregation is stopped by adding an aggregation stopper, for example, a pH-adjusting base or chelate compound or an inorganic chloride, such as sodium chloride.

After the aggregation stopper stabilizes the dispersion of the aggregated particles in the dispersion liquid, the dispersion liquid is heated to a temperature equal to or higher than the glass transition temperature or melting point of the binder resin to fuse the aggregated particles to a desired particle size. The volume distribution median diameter (D50) of the toner particles may be 3.0 μm to 10.0 μm.

### Cooling

The dispersion liquid containing toner particles obtained in the fusing step may be cooled in the cooling step, if necessary, to a temperature lower than at least either the crystallization temperature or glass transition temperature of the binder resin.

### Aftertreatment

In the process for producing the toner, after being cooled, the toner may be subjected to aftertreatment, such as cleaning, solid-liquid separation, and drying. Such aftertreatment makes the toner dry.

### External Addition

In the external addition step, inorganic fine particles A are externally added to the toner particles obtained in the drying step. In addition to inorganic fine particles A, other external additives may be added as needed. External additives may be added while a shear force is applied in a dry state.

### Emulsion Aggregation Method Including Forming Shells

The process for producing the toner may include forming shells after the toner particles (core particles) are obtained in any of the above-described methods. In the shell forming step, resin fine particles containing shell-forming resin are further added to the aqueous medium in which the core particles are dispersed to attach the shell-forming resin to the core particles and form shells. In the process of producing toner by emulsion aggregation, after aggregated particles (core particles) are formed in the aggregating step, resin fine particles containing shell-forming resin may be further added to attach the shell-forming resin to the core particles and form shells. In other words, each toner particle may have a core particle containing the binder resin and a shell over the surface of the core particle. The shell-forming resin may be the same as or different from the binder resin. The amount of the shell-forming resin to be added may be 1.0 part to 10.0 parts by mass, for example, 2.0 parts to 7.0 parts by mass, relative to 100 parts by mass of the binder resin contained in the core particles.

In this instance, the toner producing process may include the following steps:
(1) dispersing binder resin fine particles containing a binder resin to prepare a dispersion liquid of the binder resin fine particles;
(2-1) aggregating the binder resin fine particles in the binder resin fine particle dispersion liquid to form aggregates;
(2-2) forming shells by further adding resin fine particles containing a shell-forming resin to the dispersion liquid containing aggregates to attach the shell-forming resin to the aggregates, thus forming aggregates with shells; and
(3) fusing the aggregates with the shells by heating.

In an embodiment, in the above step (2-2), a boric acid source is added together with the resin fine particles containing the shell-forming resin to the dispersion liquid containing the aggregates to facilitate the presence of boric acid in the vicinity of the surfaces of the toner particles.

The boric acid source may be boric acid or a compound that can be converted into boric acid by, for example, controlling the pH during the toner production. The boric acid source may be at least one selected from the group including boric acid, borax, organic boric acid, borate salts, and borate esters. For example, a boric acid source may be added, and the dispersion liquid is controlled so that the aggregates contain boric acid. In an embodiment, the pH in the above aggregating step (2-1) is controlled to be acid, followed by forming shells.

The boric acid present in the aggregates is unsubstituted. In some embodiments, the boric acid source is boric acid or borax. When the toner particles are produced in an aqueous medium, the boric acid source may be a borate salt from the viewpoint of reactivity and production stability. More specifically, the boric salt may be at least one selected from the group including sodium tetraborate, borax, and ammonium borate. In some embodiments, borax is used.

Borax, which is represented by the decahydrate of sodium tetraborate Na₂B₄O₇, turns into boric acid in acidic aqueous solutions and is therefore suitable when boric acid is used in an aqueous medium under acidic conditions. The boric acid source to be added may be in dry powder or an aqueous solution prepared by dissolving boric acid source in an aqueous medium. In some embodiments, a boric acid source solution is added from the viewpoint of forming uniform aggregates. The boric acid source concentration in the solution can be varied depending on the concentration in the toner and may be, for example, 1.0% to 20.0% by mass. To convert the boric acid source into boric acid, the pH before, during, or after addition may be adjusted to an acidic condition. For example, the pH can be controlled to 1.5 to 5.0 or 2.0 to 4.0. In some embodiments, the pH is controlled before forming aggregates in the aggregating step.

More specifically, the pH is controlled to acidic conditions in the step of mixing the binder resin fine particle dispersion liquid and the optional release agent dispersion liquid or other dispersion liquid before the aggregating step.

### Measurements of Physical Properties

The measurements of physical properties will now be described.

### Identification and Determination of Boric Acid in the Toner Particles

The identification of boric acid and measurement of the amount of the boric acid in the toner particles are performed as described below.

### ATR-IR Spectroscopy sing Germanium (Ge) as ATR Crystal

The presence of boric acid in the toner particles can be verified using infrared (IR) absorption spectra. More specifically, toner particles from which the external additive is removed are measured by the ATR method using germanium (Ge) as the ATR crystal, as described below.

The IR analysis is conducted by the ATR method using a Fourier transform infrared spectrometer (Spectrum One, manufactured by PerkinElmer, Inc.) equipped with a universal ATR sampling accessory. Specifically, the measuring procedure is as follows:

The incident angle of IR light (λ=5 μm) is set at 45°. The ATR crystal is a Ge crystal (refractive index: 4.0). Other conditions are as follows:

### Range

Start: 4000 cm⁻¹
End: 650 cm⁻¹ (Ge ATR crystal)

### Duration

Scan number: 16
Resolution: 4.00 cm⁻¹
Advanced: CO₂/H₂O correction enabled
   (1) Install the Ge ATR crystal (refractive index: 4.0) in the analyzer.
   (2) Set “Scan type” to “Background” and “Units” to “EGY” and measure the background.
   (3) Set “Scan type” to “Sample” and “Units” to “A”.
   (4) Weigh 0.01 g of toner particles and put the particles on the ATR crystal.
   (5) Press the sample with a pressure arm. (Force Gauge: 90)
   (6) Measure the sample.

The peak at 1380 cm⁻¹, corresponding to the B—O single bond, is checked in the absorption spectrum. When an absorption peak is detected at 1380 cm⁻¹, it is determined that boric acid is detected.

### Calculation of IB/IC Ratio of Boric Acid Derived Peak IB to Carbonyl Group-Derived Peak IC

IB/IC, the ratio of the intensity IB of the absorption peak at 1380 cm⁻¹ derived from boric acid to the intensity IC of the absorption peak at 1750 cm⁻¹ to 1700 cm 1 derived from the carbonyl group of the binder resin component contained in the toner particles, is calculated in the ATR-IR spectroscopy of the toner particles.

### X-Ray Fluorescence Analysis of Toner Particles

The boric acid content of the toner particles is measured by X-ray fluorescence and determined using calibration curves. X-ray fluorescence analysis of boron is conducted according to JIS K 0119-1969, specifically described below.

The analysis uses a wavelength-dispersive X-ray fluorescence analyzer “Axios” (manufactured by Malvern Panalytical) and the accompanying dedicated software “SuperQ ver. 4.OF” (produced by Malvern Panalytical) for setting the measurement conditions and analyzing the measurement data. Using Rh as the anode of the X-ray tube, the measurement is conducted in a vacuum atmosphere for 10 s. The measurement diameter (collimator mask diameter) is 27 mm. Also, boron, which is a light element, is detected by a proportional counter (PC).

The measuring sample is a pellet of about 2 mm in thickness and about 39 mm in diameter formed by placing 4 g of toner particles in a special aluminum press ring, flatting the particles, and pressing the particles at 20 MPa for 60 seconds using a tablet-forming press machine BRE-32 (manufactured by Maekawa Testing Machinery Mfg. Co., Ltd.). Then, the count rate (unit: cps) of B-Ka rays observed at a diffraction angle (2θ) of 41.75° when a PET analyzing crystal is used is measured.

In this measurement, the acceleration voltage and current of the X-ray generator are set at 32 kV and 125 mA, respectively.

Also, the amount (% by mass) of boric acid in the toner particles is determined from the separately prepared boric acid calibration curve. The toner particles from which the external additive is removed may be used for the measurement. Separation and Collection of Toner Particles and Inorganic Fine Particles A from Toner

A concentrated sucrose solution is prepared by dissolving 160 g of sucrose (produced by Kishida Chemical Co., Ltd.) in 100 mL of ion-exchanged water being heated in hot water. Into a centrifuge tube (capacity: 50 mL) are added 31 g of the concentrated sucrose solution and 6 mL of CONTAMINON N (10 mass % aqueous solution of pH 7 neutral detergent for cleaning precision measuring instruments, containing nonionic and anionic surfactants and an organic builder, produced by FUJIFILM Wako Pure Chemical Corporation). Then, 1.0 g of the toner is added into the centrifuge tube, followed by diffusing aggregates of the toner with a spatula or the like. The centrifuge tube is shaken with a shaker AS-IN (available from AS ONE Corporation) at 300 spm (strokes per min) for 20 minutes. After shaking, the liquid is removed into a swing rotor glass tube (50 mL) and subjected to separation in a centrifuge H-9R (manufactured by Kokusan Co., Ltd.) at 3500 rpm for 30 minutes.

Thus, the toner particles and the external additive are separated. After visually confirming that the toner particles and the liquid phase are sufficiently separated, the separated toner particles and external additive are collected with a spatula or the like. When the inorganic fine particles A are mixed with other external additives, the external additives are further separated for isolation by centrifugation using the differences in particle size and specific gravity to obtain the targeted object. The procedure up to this is repeated several times to obtain desired amounts of toner and inorganic fine particles A. The collected toner particles and inorganic fine particles are subjected to vacuum filtration and then dried for at least 1 hour to yield test samples. The procedure up to this is repeated several times to obtain desired amounts of samples.

### Identification of Constitutional Elements and Crystal System of Inorganic Fine Particles A

The constitutional elements and crystal system of inorganic fine particles A are identified by SEM-EDS and X-ray diffraction analyses of the inorganic fine particles A isolated as described above.

### SEM-EDS Analysis of Inorganic Fine Particles A

For the identification of the constitutional elements of inorganic fine particles A, profile observation by scanning electron microscopy (SEM) and ultimate analysis by energy dispersive X-ray analysis (EDS) can be combined.

The isolated inorganic fine particles A are observed under a scanning electron microscope, “Ultra Plus” (trade name), manufactured by Carl Zeiss AG. Also, the inorganic fine particles A are subjected to EDS analysis, and the constitutional elements are identified from the presence of element peaks.

When the peaks of the elements that can constitute inorganic fine particles, that is, the peaks of N and at least one of the group 13 elements B, Al, and Ga, are observed, inorganic fine particles A are analogically considered a nitride of any of the group 13 elements of the periodic table.

### X-Ray Diffraction Analysis of Inorganic Fine Particles A

The crystal system of inorganic fine particles A can be identified by X-ray diffraction analysis of the inorganic fine particles A collected from the toner.

For X-ray diffraction, an analyzer RINT-TTR II (manufactured by Rigaku Corporation) and the accompanying control and analysis software programs are used. The analysis is performed under the following conditions:
X-ray radiation: Cu/50 kV/300 mA
Goniometer: Rotor horizontal goniometer (TTR-2)
Attachment: Standard sample holder
Divergence slit: open
Divergence vertical limit slit: 10.00 mm
Scattering slit: open
Receiving slit: open
Counter: scintillation counter
Scanning mode: continuous
Scanning speed: 4.0000°/min
Sampling width: 0.0200°
Scanning axis: 2θ/deg
Scanning range: 3.0000° to 60.0000°

The thus obtained spectrum is analyzed by the software programs

accompanied by the analyzer. When the peaks match those detected in nitrides of group 13 elements of the periodic table having a hexagonal crystal structure, the crystal structure of the sample is determined to be hexagonal.

### Graphitization Index (GI) Measurement of Boron Nitride Particles

The graphitization index GI of boron nitride inorganic fine particles A is represented by the ratio of the peak intensities of (100), (101), and (102) planes of boron nitride particles in the above X-ray diffraction spectrum and calculated from the following equation:

GI value=[area{(100)+(101)}]/[area (102)]

### Measurement of Inorganic fine particles A content of Toner

The inorganic fine particles A content of the toner can be estimated by X-ray fluorescence analysis (XRF) of the toner from which the external additive is removed in the above-described manner.

The measurement uses a wavelength-dispersive X-ray fluorescence analyzer “Axios” (manufactured by Malvern Panalytical) and the accompanying dedicated software “SuperQ ver. 4.OF” (produced by Malvern Panalytical) for setting the measurement conditions and analyzing the measurement data. Using Rh as the anode of the X-ray tube, the measurement is conducted in a vacuum atmosphere for 10 s. The measurement diameter (collimator mask diameter) is 27 mm. Also, boron, which is a light element, is detected by a proportional counter (PC).

The measuring sample is a pellet of about 2 mm in thickness and about 39 mm in diameter formed by placing 4 g of toner in a special aluminum press ring, flatting the particles, and pressing the particles at 20 MPa for 60 seconds using a tablet-forming press machine BRE-32 (manufactured by Maekawa Testing Machinery Mfg. Co., Ltd.). Then, the count rates (intensities) (unit: cps) of the group 13 elements are measured using the pellet.

In this measurement, the acceleration voltage and current of the X-ray generator are set at 32 kV and 125 mA, respectively.

### Calculation of Intensity Fraction of the Group 13 Elements in Inorganic Fine Particles A of the Toner

The toner particles from which inorganic fine particles A are removed from the surface of the toner are subjected to the same measurement as described above to calculate the fraction of the intensity of the group 13 elements contained in inorganic fine particles A to the intensity of the group 13 elements in the toner sample. The intensity of the group 13 elements in inorganic fine particles A can be calculated from the intensity of the group 13 elements in the toner before removing inorganic fine particles A and the intensity of the group 13 elements after removing inorganic fine particles A using the following equation:

(Intensity fraction of the group 13 elements contained in inorganic fine particles A)=(group 13 element intensity before removing inorganic fine particles A−group 13 element intensity after removing inorganic fine particles A)/(group 13 element intensity before removing inorganic fine particles A)

The inorganic fine particle A content (% by mass) of the toner is estimated from the obtained intensity fraction of the group 13 element contained in inorganic fine particles A using a separately prepared calibration curve of inorganic fine particles A. Measurement of Number Average Particle Size and D/T of Inorganic Fine Particles A

The number average particle size of inorganic fine particles A is measured with a scanning electron microscope “Ultra Plus” (trade name), manufactured by Carl Zeiss AG. For the identification of inorganic fine particles A, SEM-EDS Analysis is applied.

The toner is observed under the following conditions, and the primary particle size, longer diameter D (nm), and thickness T (nm) of 100 particles of inorganic fine particles A are measured. The average of longer diameter measurements (D) is defined as the number average particle size, and the average of the proportions of the longer diameter to the thickness of individual particles is defined as D/T. The observation magnification is adjusted accordingly depending on the size of the inorganic fine particles.

### SEM Observation Conditions

Sample Pretreatment: Pt coating the toner secured with carbon tape on the tip of a conical sample base

SEM acceleration voltage: 2.0 kV
WD: 2.8 mm
Detector: SE2
Sample tilt angle: −45° to 45° (observing the thinnest portion of inorganic particles A)
Observation magnification: 5,000 to 50,000 times

### Measurement of Weight Average Particle size (D4) and Number Average Particle Size (D1) of Toner or Toner particles

The weight average particle size (D4) and number average particle size (D1) of the toner or toner particles are measured by a pore electric resistance method with a 100 μm aperture tube, using a precise particle size distribution analyzer “Coulter Counter Multisizer 3” (registered trademark) manufactured by Beckman Coulter, Inc. and the accompanying software program “Beckman Coulter Multisizer 3 Version 3.51” produced by Beckman Coulter, Inc. for setting measuring conditions and analyzing measurement data. The measurement is performed with the effective number of measurement channels set to 25,000, and measurement data is analyzed and calculated.

The electrolyte solution used for the measurement may be prepared by dissolving highest-quality sodium chloride in ion-exchanged water to about 1% by mass, and, for example, ISOTON II (produced by Beckman Coulter, Inc.) may be used.

Before the measurement and analysis, the above-mentioned accompanying software is set up as described below.

On the “standard measurement (SOM) change screen” (translation) of the software, the total count in the control mode is set to 50,000 particles; the number of measurements, to 1; and Kd, to the value obtained by using “10.0 μm standard particles” (produced by Beckman Coulter, Inc.) Press the threshold/noise level measurement button to automatically set the threshold and noise level. The Current is set to 1600 μA; the Gain, to 2; and the electrolyte solution, to ISOTON II. A checkmark is placed at the statement “flush of aperture tube after measurement” (translation).

On the “Pulse-to-Particle Size Conversion Setting Screen (translation)” of the software, the bin distance is set to logarithmic particle size, the particle size bin, to 256 particle size bins, and the particle size range, to a range of 2 μm to 60 μm.

Specifically, the measurement is performed according to the following procedure:
(1) About 200 mL of the electrolyte solution is placed in a Multisizer-3-specific 250 mL glass round bottom beaker, and stirred with a stirrer rod counterclockwise at 24 revolutions per second with the beaker set on a sample stand. The dirt and air bubbles in the aperture tube are removed by the “Aperture Flush” function of the software.
(2) About 30 mL of the electrolyte solution is placed in a 100 mL glass flat bottom beaker, and into which is added about 0.3 mL of a solution prepared by diluting CONTAMINON N to three times its mass with ion-exchanged water. CONTAMINON N is a 10 mass % aqueous solution of a pH 7 neutral detergent for precision measurement instruments, produced by FUJIFILM Wako Pure Chemical Corporation and contains a nonionic surfactant, an anionic surfactant, and an organic builder.
(3) About 2 mL of CONTAMINON N is added to a predetermined amount of deionized water in a water tank of an ultrasonic dispersion system Tetora 150 (manufactured by Nikkaki Bios) having an electric power of 120 W, containing two oscillators of 50 kHz in oscillation frequency with the phases shifted by 180°.
(4) The beaker of the above (2) is set to a beaker securing hole of the ultrasonic dispersion system, and the ultrasonic dispersion system is started. Then, the height of the beaker is adjusted so that the resonance at the level of the electrolyte solution in the beaker can be largest.
(5) About 10 mg of the toner or toner particles are gradually added to and dispersed in the electrolyte solution in the beaker of the above (4) to which ultrasonic waves are applied. Such ultrasonic dispersion is further continued for 60 seconds. For the ultrasonic dispersion, the water temperature in the water tank is appropriately controlled in the range of 10° C. to 40° C.
(6) The electrolyte solution of the above (5), in which the toner or toner particles are dispersed, is dropped with a pipette into the round bottom beaker of the above (1) set on the sample stand to adjust the measurement concentration to about 5%. Then, the measurement is performed until the number of measured particles reaches 50,000.
(7) The measurement data is analyzed with the software, and the weight-average particle size (D4) is calculated. “Average size” on the “Analysis/Volume Statistic Value (Arithmetic Mean)” (translation) screen when graph/volume% is set on the software is the weight average particle size (D4), and “Average size” on the “Analysis/Number Statistic Value (Arithmetic Mean)” (translation) screen when graph/number% is set on the software is the number average particle size.

Measurement of the Amount of Oxygen Atom in Inorganic Fine Particles A

The amount of oxygen atom in inorganic fine particles A is measured under the following conditions with an oxygen, nitrogen, and hydrogen analyzer ONH836 (manufactured by LECO Corporation).
Sample weight: 0.50 g, automatically dropped
Analysis delay: 50 s

### Furnace Parameters

Out gas cycle: 2
Out gas time: 15 s
Power: 5500 W

### Element Parameters

Integration delay: 4 s

Integration time: 40 s

### Adhesion Measurement Using Polycarbonate Thin Film

The amount of adhering inorganic fine particles A is measured by an adhesion measurement method using a polycarbonate thin film. In this measurement, SEM images of polycarbonate thin films taken under a scanning electron microscope Ultra Plus (manufactured by Carl Zeiss AG.) are analyzed with an image analyzing software program Image-Pro Plus ver. 5.0 (produced by Media Cybernetics), followed by calculating the adhesion amount. Sample preparation and photographing conditions with Ultra Plus are as follows.

### (1) Sample Preparation

A 5 mm×5 mm square conductive carbon tape is attached to a sample base (15 mm×6 mm aluminum sample base), and a polycarbonate thin film (5.0 mm×5.0 mm square bisphenol Z thin film, Iupilon Z200 (trade name), manufactured by Mitsubishi Gas Chemical Company) is stuck over the conductive carbon tape.

The toner (0.4 mg) is put on this polycarbonate thin film, and the sample base is lifted to a height of 5 mm and dropped 30 times under its own weight without acceleration so that the toner uniformly spreads over the thin film. Then, nitrogen gas air with an air pressure of 0.2 MPa is blown over the surface of the polycarbonate thin film at an angle of 45° with a distance kept 1 cm from the center of gravity of the thin film, using an air duster gun (K-601-0, Kinki Seisakusho).

### (2) SEM Observation Conditions

Sample pretreatment: Samples are coated with Pt after the above-described operation.
SEM acceleration voltage: 2.0 kV
Detector: SE2
WD: 2.8 mm
Sample tilt angle: 0°
Observation magnification: 5,000 times (1280 pixels × 960 pixels)

Randomly selected 300 fields of view are observed, and 300 images are taken.

### (3) Image Analysis

The amount of adhesion of inorganic fine particles A, described herein, is calculated by binarizing the images taken as above using the analyzing software program, Image-Pro Plus ver. 5.0, under the following conditions.

Select “Measurement” on the toolbar, then “Calibration” and “Spatial Calibration”, in this order, to set the scale for the actual SEM observation conditions. Next, select “Rectangle AOI” on the toolbar, select the area other than the text information displayed in the image, and set the area of the rectangle to 28.2 μm². Next, select “Measurement” and “Count/Size” and then select “Manual Extraction” to set the threshold so that inorganic fine particles A on the image are colored. Also, select “Area” under “Measurement Item” in “Measurement” in “Count/Size” to enable area measurement. Next, run “Count” under “Count/Size” and “Fill Holes” under “Edit” in “Count/Size” to confirm that the inorganic fine particles A to be measured are correctly selected. If foreign matter, apart from inorganic fine particles A, is present, select “Exclude Object” under “Edit” in “Count/Size” to exclude the foreign matter. After these settings, run “Count” under “Count/Size” to obtain the area of each inorganic fine particle A. This measurement is performed on the observed 300 images.

### (4) Determination of the Amount of Adhesion of Inorganic Fine Particles A

The amount of adhesion of inorganic fine particles A measured by an adhesion measurement method using a polycarbonate thin film is defined as follows:

[Amount of adhesion of inorganic fine particles A measured by adhesion measurement method using a polycarbonate thin film]=[Sum of areas of inorganic fine particle A/(28.2 μm² in area of entire polycarbonate thin film×number of images)]

### EXAMPLES

The present disclosure will be further described in detail with reference to the following Examples and Comparative Examples, which are however not intended to limit the disclosure. In Examples, “part(s)” is on a mass basis unless otherwise specified.

### Production of Toner Particles 1

### Synthesis of Polyester Resin 1

Bisphenol A ethylene oxide 2 mol adduct: 9 parts by mole
Bisphenol A propylene oxide 2 mol adduct: 95 parts by mole
Terephthalic acid: 50 parts by mole
Fumaric acid: 30 parts by mole
Dodecenylsuccinic acid: 25 parts by mole

A flask equipped with a stirrer, a nitrogen inlet tube, a temperature sensor, and a rectifying column was charged with the above monomers, and the temperature was raised to 195° C. in 1 hour, followed by ensuring that the reaction system was uniformly stirred. To 100 parts of the monomers was added 1.0 part of tin distearate. The temperature was raised from 195° C. to 250° C. over a period of 5 hours while removing the water being produced, and a dehydration condensation reaction was performed at 250° C. for another 2 hours.

As a result, polyester resin 1 was obtained, which had a glass transition temperature of 60.2° C., an acid value of 16.8 mg KOH/g, a hydroxy value of 28.2 mg KOH/g, a weight average molecular weight of 11,200, and a number average molecular weight of 4,100.

### Synthesis of Polyester Resin 2

Bisphenol A ethylene oxide 2 mol adduct: 48 parts by mole
Bisphenol A propylene oxide 2 mol adduct: 48 parts by mole
Terephthalic acid: 65 parts by mole
Dodecenylsuccinic acid: 30 parts by mole

A flask equipped with a stirrer, a nitrogen inlet tube, a temperature sensor, and a rectifying column was charged with the above monomers, and the temperature was raised to 195° C. in 1 hour, followed by ensuring that the reaction system was uniformly stirred. To 100 parts of the monomers was added 0.7 part of tin distearate. The temperature was raised from 195° C. to 240° C. over a period of 5 hours while removing the water being produced, and a dehydration condensation reaction was performed at 240° C. for another 2 hours. Then, the temperature was lowered to 190° ° C., 5 parts by mole of anhydrous trimellitic acid was gradually added, and the reaction continued at 190° C. for 1 hour.

As a result, polyester resin 2 was obtained, which had a glass transition temperature of 55.2° C., an acid value of 14.3 mg KOH/g, a hydroxy value of 24.1 mg KOH/g, a weight average molecular weight of 43,600, and a number average molecular weight of 6,200.

### Preparation of Resin Particle Dispersion Liquid 1

Polyester resin 1: 100 parts
Methyl ethyl ketone: 50 parts
Isopropyl alcohol: 20 parts

Methyl ethyl ketone and isopropyl alcohol were added to a vessel. Then, the resin was gradually added to the vessel and fully dissolved with stirring to yield a solution of polyester resin 1. The vessel containing the solution of polyester resin 1 was set to 65° ° C., and 10% ammonia solution was gradually dropped to 5 parts in total with stirring. Additionally, 230 parts of ion-exchanged water was gradually dropped at a rate of 10 mL/min for phase inversion emulsification. Furthermore, the solvent was removed by reducing the pressure with an evaporator to yield resin particle dispersion liquid 1 of polyester resin 1. The resin particles in the dispersion liquid had a volume average particle size of 135 nm. The resin particle solids content was adjusted with ion-exchange water to 20%.

### Preparation of Resin Particle Dispersion Liquid 2

After adding 50 parts of methyl ethyl ketone and 20 parts of isopropyl alcohol into a vessel, 100 parts of polyester resin 2 was gradually added to the vessel and fully dissolved with stirring to yield a solution of polyester resin 2. The vessel containing the solution of polyester resin 2 was set to 40° C., and 10% ammonia solution was gradually dropped to 3.5 parts in total with stirring. Additionally, 230 parts of ion-exchanged water was gradually dropped at a rate of 10 mL/min for phase inversion emulsification. Furthermore, the solvent was removed by reducing the pressure to yield resin particle dispersion liquid 2 of polyester resin 2. The resin particles in the dispersion liquid had a volume average particle size of 155 nm. The resin particle solids content was adjusted with ion-exchange water to 20%.

Preparation of Coloring Agent particle Dispersion Liquid
Copper phthalocyanine (Pigment Blue 15:3, produced by Dainichiseika Color & Chemicals Mfg. Co., Ltd.): 45 parts
Ionic surfactant Neogen RK (produced by Dai-ichi Kogyo Seiyaku Co., Ltd.): 5 parts
Ion-exchanged water: 190 parts

The above constituents were mixed and dispersed in each other for 10 minutes with a homogenizer (ULTRA-TURRAX, manufactured by IKA). The mixture was further dispersed with a counter-collision wet grinder Ultimizer (manufactured by Sugino Machine) at a pressure of 250 MPa for 20 minutes to yield a coloring agent particle dispersion liquid having a volume average particle size of 120 nm and a solid content of 20%.

Preparation of Release agent Particle Dispersion Liquid
Release agent (hydrocarbon wax with a melting point of 79° C.): 15 parts
Ionic surfactant Neogen RK (produced by Dai-ichi Kogyo Seiyaku Co., Ltd.): 2 parts
Ion-exchanged water: 240 parts

These constituents were heated to 100° C. and sufficiently dispersed in each other with LTRA-TURRAX T50, manufactured by IKA. Then, the mixture was further dispersed at 115° C. for 1 hour using a high-pressure Gaulin homogenizer to yield a release agent particle dispersion liquid having a volume average particle size of 160 nm and a solid content of 20%.

### Production of Toner Particles 1

Resin particle dispersion liquid 1: 500 parts
Resin particle dispersion liquid 2: 400 parts
Coloring agent particle dispersion liquid: 50 parts
Release agent particle dispersion liquid: 80 parts

For forming cores, first, these materials were mixed in a stainless steel round flask. Subsequently, the mixture was dispersed at 5000 r/min for 10 minutes with the homogenizer LTRA-TURRAX T50 (manufactured by IKA). After adjusting the pH to 3.0 with 1.0% nitric acid aqueous solution, the mixture was heated up to 58° C. in a heating water bath while being stirred with a stirring blade at rotational speeds appropriately adjusted to ensure the stirring. The volume average particle size of aggregated particles was measured as needed with Coulter Multisizer III during forming cores. As 5.0 μm aggregated particles (cores) were formed, the following materials were added and stirred for another 1 hour to form shells.
Resin particle dispersion liquid 1: 40 parts
Ion-exchanged water: 300 parts
10.0 mass % borax aqueous solution: 19 parts

(borax: sodium tetraborate decahydrate, produced by FUJIFILM Wako Pure Chemical Corporation)

Then, the pH was adjusted to 9.0 with 5% sodium hydroxide aqueous solution, and the particles were heated up to 89° C. with stirring. When a desired surface profile was obtained, heating was stopped, and the particles were cooled to 25° C., followed by filtration, solid-liquid separation, and rinsing with ion-exchanged water. After being rinsed, the particles were dried in a vacuum dryer to yield toner particles 1 with a volume average particle size (D4) of 6.8 μm. The physical properties of the resulting toner particles 1 are presented in Table 1.

### Production of Toner Particles 2 to 5 and 8

Toner particles 2 to 5 and 8 were produced in the same manner as toner particles 1, except that the materials and conditions used were changed, as shown in Table 1. The physical properties of the resulting toner particles 2 to 5 and 8 are presented in Table 1.

### Production of Toner Particles 6

Into a four-neck vessel were added 710 parts ion-exchanged water and 850 parts of 0.1 mol/L Na3PO4 aqueous solution, and the contents were kept at 60° C. while being stirred at 12,000 rpm with T. K. Homo Mixer. Into the vessel, 68 parts of 1.0 mol/L CaCl₂ aqueous solution was gradually added to prepare an aqueous dispersion medium containing fine particles of a poorly water-soluble dispersion stabilizer Ca₃(PO₄)₂.
Styrene: 76 parts
n-Butyl acrylate: 24 parts
Copper phthalocyanine (Pigment Blue 15:3, produced by Dainichiseika Color & Chemicals Mfg. Co., Ltd.): 6.5 parts
Polyester resin 3: 5 parts

(Terephthalic acid-propylene oxide-modified bisphenol A (2-mole adduct), mole ratio: 51:50, acid value: 10 mg KOH/g, glass transition temperature: 70° C., Mw: 10,500, Mw/Mn: 3.20)
Negative charge control agent (aluminum 3,5-di-tert-butylsalicylate): 0.4 part
Fischer-Tropsch wax (maximum endothermic peak temperature: 75° C.): 7.5 parts
10.0 mass % borax aqueous solution: 19.0 parts

These materials were dispersed in polymerizable monomers by being stirred for 3 hours with an attritor to prepare a monomer mixture. To the monomer mixture, 10.0 parts of 1,1,3,3-tetramethylbutyl peroxy-2-ethylhexanoate (50% toluene solution) was added as a polymerization initiator to prepare a polymerizable monomer composition. The polymerizable monomer composition was added to the aqueous dispersion medium and granulated at a constant rotational speed of 10,000 rpm for 5 minutes. Then, the high-speed stirrer was replaced with a stirrer with a propeller stirring blade, and the interior was heated to 70° C. and subjected to a reaction gradually over a period of 6 hours with slow stirring.

Subsequently, the temperature in the vessel was raised to 80° C .and maintained for 4 hours. Then, the contents were gradually cooled to 30° C. at a cooling rate of 1° C. per minute to yield a slurry. Dilute hydrochloric acid was added to the vessel containing the slurry to remove the dispersion stabilizer. Furthermore, the contents were subjected to filtration, rinsing, and drying to yield toner particles 6. The physical properties of toner particles 6 are presented in Table 1.

### Production of Toner Particles 7

Polyester resin 1: 60.0 parts
Polyester resin 2: 40.0 parts
Copper phthalocyanine pigment (Pigment Blue 15:3, produced by Dainichiseika Color & Chemicals Mfg. Co., Ltd.): 6.5 parts
Release agent (hydrocarbon wax with a melting point of 79° C.): 5.0 parts Plasticizer (ethylene glycol distearate): 15.0 parts
Boric acid powder (produced by FUJIFILM Wako Pure Chemical Corporation): 1.5 parts

These materials were premixed with an FM mixer (manufactured by Nippon Coke & Engineering Co., Ltd.), and then, the mixture was melted and kneaded with a twin-screw extruder PCM-30 (manufactured by Ikegai Corp.) The resulting kneaded product was cooled and roughly crushed with a hammer mill. After 130 parts of ethyl acetate was added, the kneaded product was heated to 80° C. and stirred at 5000 rpm for 1 hour with T. K. Homo Mixer (manufactured by PRIMIX Corporation), followed by cooling to 30° C. to yield a solution.

Into another vessel, 400 parts of water and 5 parts of ELEMINOL MON-7 (produced by Sanyo Chemical Industries, Ltd.) were added, and then, 100 parts of the above-prepared solution was added at 30° ° C.with stirring at 13,000 rpm with T. K. Homo mixer (manufactured by PRIMIX Corporation) and followed by stirring for another 20 minutes to yield a slurry. The solvent was removed under reduced pressure at 30° C. for 8 hours with the resulting slurry slowly stirred, followed by aging at 45° C. for 4 hours. Thus, toner particles 7 were obtained through rinsing, filtration, and drying.

The physical properties of the resulting toner particles 7 are presented in Table 1.

TABLE 1

| | | Amount | | Percentage | Boric acid-derived | | Weight |
|---|---|---|---|---|---|---|---|
| | | by parts | | of boric acid | peak intensity | | average |
| | Tone | of boric | | in toner | (kcps) in X-ray | | particle |
| Toner | production | acid | | particles | fluorescence | | size (D4) |
| particles | method | component | | (mass %) | analysis | I_{B}/I_{C} | (μm) |
| 1 | Emulsion | 10.0 mass % | 19.0 | 1.0 | 0.15 | 0.15 | 6.1 |
| | aggregation | Borax aqueous solution | | | | | |
| 2 | Emulsion | 10.0 mass % | 9.1 | 0.5 | 0.11 | 0.10 | 6.2 |
| | aggregation | Borax aqueous solution | | | | | |
| 3 | Emulsion | 10.0 mass % | 57.0 | 3.0 | 0.25 | 0.19 | 6.2 |
| | aggregation | Borax aqueous solution | | | | | |
| 4 | Emulsion | 40.0 mass % | 51.0 | 10.0 | 0.60 | 0.29 | 6.2 |
| | aggregation | Borax aqueous solution | | | | | |
| 5 | Emulsion | 10.0 mass % | 3.6 | 0.2 | 0.10 | 0.02 | 6.2 |
| | aggregation | Borax aqueous solution | | | | | |
| 6 | Suspension | 10.0 mass % | 19.0 | 1.0 | 0.15 | 0.04 | 6.4 |
| | | Borax aqueous solution | | | | | |
| 7 | Pulverization | Borax powder | 1.5 | 1.0 | 0.14 | 0.03 | 7.0 |
| 8 | Emulsion | — | 0.0 | 0.0 | 0.00 | 0.00 | 6.3 |
| | aggregation | | | | | | |

### Preparation of Boron Nitride Particles

Boron nitride particles are obtained by reacting the raw material, as boric acid, borates, or molten boric anhydride, with ammonia for nitridation reduction in a synthesis furnace, followed by purification and crystallization. Boron nitride particles (A1 to A12) were prepared under conditions where the mixing ratio of boric acid and ammonia, catalyst, reaction temperature, and reaction time in this process were varied.

Table 2 presents the properties of inorganic fine particles A including boron nitride particles: crystal system, GI value, the number average particle size of primary particles, D/T ratio of the longer diameter D (nm) of each particle to its thickness T (nm), and oxygen atom content.

TABLE 2

| | Material | | | Number average | | Oxygen |
|---|---|---|---|---|---|---|
| | of inorganic | Crystal | GI | particle size (nm) of | | content |
| | fine particles A | system | value | primary particles | D/T | (mass %) |
| A1 | Boron nitride | Hexagonal | 3.0 | 610 | 12.0 | 1.10 |
| A2 | Boron nitride | Hexagonal | 1.7 | 650 | 5.5 | 0.50 |
| A3 | Boron nitride | Hexagonal | 8.0 | 550 | 19.4 | 1.90 |
| A4 | Boron nitride | Hexagonal | 7.6 | 460 | 4.6 | 2.00 |
| A5 | Boron nitride | Hexagonal | 1.9 | 980 | 19.6 | 0.10 |
| A6 | Boron nitride | Hexagonal | 8.2 | 296 | 6.3 | 2.30 |
| A7 | Boron nitride | Hexagonal | 2.1 | 2000 | 21.1 | 0.40 |
| A8 | Boron nitride | Hexagonal | 5.1 | 296 | 3.0 | 1.55 |
| A9 | Boron nitride | Hexagonal | 9.2 | 2000 | 52.6 | 2.60 |
| A10 | Boron nitride | Hexagonal | 1.6 | 1870 | 12.7 | 0.05 |
| A11 | Boron nitride | Hexagonal | 10.0 | 600 | 3.1 | 2.97 |
| A12 | Boron nitride | Hexagonal | 10.0 | 600 | 2.2 | 2.97 |
| A13 | Aluminum nitride | Wurtzite structure | — | 1000 | 3.0 | 0.90 |
| | (HF-01D, Tokuyama | (Hexagonal) | | | | |
| | Corporation) | | | | | |
| A14 | Boron nitride | Sphalerite | — | 1000 | 2.8 | 0.90 |
| | (FBN-AM, Global | (Cubic) | | | | |
| | Diamond Co., Ltd.) | | | | | |
| A15 | Silicon nitride | Wurtzite structure | — | 2000 | 2.7 | 0.90 |
| | (SSN-β1, Shin-Etsu | (Hexagonal) | | | | |
| | Chemical Co., Ltd.) | | | | | |

### Production of Toner 1

Toner particles 1 were subjected to external addition to obtain toner 1 by dry-mixing 100.0 parts of toner particles 1, 0.50 part of inorganic fine particles A1, 0.80 part of silica fine particles (surface-treated 20% by mass of hexamethyldisilazane, primary particle size: 16 nm), and 2.00 parts of titanium oxide particles (FTL-100, produced by Ishihara Sangyo Kaisha, Ltd., longer diameter: 1.7 μm, aspect ratio: 10) at 38 m/s for 5 minutes with a Henschel mixer (manufactured by Nippon Coke & Engineering Company, Limited). The physical properties of the resulting toner 1 are presented in Table 3.

### Preparation of Toners 2 to 26

Toners 2 to 26 were produced in the same manner as toner 1. except that the materials and amounts of the toner particles and inorganic fine particles A and the amount of titanium oxide particles were changed, as presented in Table 3. The physical properties of the resulting toners 2 to 26 are presented in Table 3.

TABLE 3

| | | | | | Adhesion area |
|---|---|---|---|---|---|
| | | Inorganic fine | | Titanium oxide | of inorganic |
| | | particles A | | particles | fine particles |
| | Toner | | Amount by | Amount by | A to polycarbon- |
| Toner | particles | No. | parts added | parts added | ate film (%) |
| 1 | 1 | 1 | 0.50 | 2.00 | 0.01 |
| 2 | 1 | 2 | 0.50 | 2.00 | 0.04 |
| 3 | 1 | 3 | 0.50 | 2.00 | 0.02 |
| 4 | 1 | 4 | 0.50 | 2.00 | 0.05 |
| 5 | 1 | 5 | 0.50 | 5.00 | 0.21 |
| 6 | 1 | 6 | 0.50 | 1.00 | 0.08 |
| 7 | 1 | 7 | 0.50 | 0.00 | 0.29 |
| 8 | 1 | 8 | 0.50 | 0.00 | 0.20 |
| 9 | 1 | 9 | 0.50 | 0.00 | 0.24 |
| 10 | 2 | 9 | 0.50 | 0.00 | 0.28 |
| 11 | 3 | 9 | 0.50 | 0.00 | 0.08 |
| 12 | 4 | 9 | 0.50 | 0.00 | 0.05 |
| 13 | 5 | 9 | 0.50 | 0.00 | 0.30 |
| 14 | 5 | 9 | 2.50 | 0.00 | 0.35 |
| 15 | 5 | 9 | 0.20 | 0.00 | 0.10 |
| 16 | 5 | 9 | 5.00 | 0.00 | 0.42 |
| 17 | 5 | 9 | 0.01 | 0.00 | 0.06 |
| 18 | 5 | 13 | 0.01 | 0.00 | 0.38 |
| 19 | 5 | 10 | 0.01 | 0.00 | 0.40 |
| 20 | 5 | 11 | 0.01 | 0.00 | 0.02 |
| 21 | 6 | 11 | 0.01 | 0.00 | 0.46 |
| 22 | 7 | 11 | 0.01 | 0.00 | 0.49 |
| 23 | 1 | 15 | 0.50 | 0.00 | 1.80 |
| 24 | 1 | 14 | 0.50 | 0.00 | 1.12 |
| 25 | 8 | 12 | 0.50 | 0.00 | 2.12 |
| 26 | 1 | — | 0.00 | 0.00 | — |

### Example 1

Toner 1 was evaluated as described below.

### Examination

A printer modified from a commercially available laser beam printer.

“LBP9900Ci”, manufactured by Canon Inc., was used. The modification was made by changing the gears in the apparatus proper and the software so that the developing roller rotates at twice the peripheral speed of the drum. Also, the pre-exposure device was removed from the laser beam printer. Such modification promotes the transfer of the external additives from the toner, so that the evaluation of changes in image density, transferability of the toner from the electrostatic latent image bearing member after long-time paper feeding, and the charged level of the toner can be performed under more severe conditions.

Next, the electrophotographic apparatus and the process cartridge were allowed to stand in an environment of 23° C. and 50% RH for 48 hours to acclimate them to the measurement environment. After the acclimation, in the same normal temperature and humidity environment (23° C/50% RH), images with a print coverage of 4.0% were printed in the lateral direction on the mid area of 40,000 sheets of LETTER-size Business 4200 paper (75 g/m², manufactured by XEROX Holding Corporation), with 50 mm margins on the left and right sides, and the image densities of the initially printed image and the image after printing 40,000 sheets were evaluated.

The evaluation results are presented in Table 4.

### Evaluation 1: Image Density Maintenance

For evaluating image density, solid images were printed over the entire surfaces of three sheets after the above paper feeding test, and the image on the third sheet was evaluated. The density of the printed image was measured at 5 points with a spectroscopic densitometer (500 series, manufactured by X-Rite, Inc.), and the measurements at 5 points were averaged as the image density used in the following index:

Image density maintenance rate=(initial image density−image density after paper feeding test)/initial image density

### Criteria:

A: Image density maintenance rate after the paper feeding test is 90% or more relative to the initial image density.
B: Image density maintenance rate after the paper feeding test is 80% to less than 90% relative to the initial image density.
C: Image density maintenance rate after the paper feeding test is 70% to less than 80% relative to the initial image density.
D: Image density maintenance rate after the paper feeding test is less than 70% relative to the initial image density.

### Evaluation 2: Transfer Stability

Transfer stability was evaluated. A solid image was printed, and the toner remaining on the electrostatic latent image bearing member after printing the solid image was taped off using transparent polyester adhesive tape. The difference in density was calculated by subtracting the density of the adhesive tape alone stuck on paper from the density of the removed adhesive tape stuck on paper.

After feeding 40,000 sheets, this test was performed, and the difference in density was evaluated as follows. The density was measured with a color reflection densitometer (X-rite 500 series, manufactured by X-Rite, Inc.)

### Criteria:

A: Difference in density is less than 0.05 after feeding 40,000 sheets.
B: Difference in density is 0.05 to less than 0.11 after feeding 40,000 sheets.
C: Difference in density is 0.11 to less than 0.40 after feeding 40,000 sheets.
D: Difference in density is more than 0.40 after feeding 40,000 sheets.

### Evaluation 3: Charge Quantity and Charge Stability

The charge (μC/g) of the toner on the developed image bearing member in the toner cartridge was measured using a blow-off powder charge measuring apparatus TB-200 (manufactured by KYOCERA Chemical Corporation) at the initial stage (after feeding 10 sheets) and after feeding 40,000 sheets in the above test, and the chargeability and charge stability were evaluated.

The larger the absolute value of charge quantity, the higher the chargeability of the toner; and the smaller the difference between the charge quantity at the initial stage and after feeding 40,000 sheets, the better the charge stability of the toner. The charge quantity and the charge stability were evaluated according to the following criteria:

### Criteria:

### Initial Charge

A: Less than −30.0 C/g in charge quality
B: −30.0 μC/g to less than −27.5 μC/g in charge quality
C: −27.5 μC/g to less than −22.5 μC/g in charge quality
D: more than -22.5 μC/g in charge quality

### Charge Stability

In terms of the difference between charge quantity at the initial stage and after feeding 40,000 sheets,
A: more than −2.0 μC/g
B: more than −4.0 μC/g to −2.0 μC/g
C: more than −6.0 μC/g to −4.0 μC/g
D: −6.0 μC/g or less

### Example 2 to 22

The same evaluations were made as in Example 1, except for using toners 2 to 22. The evaluation results are presented in Table 4.

### Comparative Examples 1 to 4

The same evaluations were made as in Example 1, except for using toners 23 to 26. The evaluation results are presented in Table 4.

TABLE 4

| | | Image density | | | | Initial | | Charge | |
|---|---|---|---|---|---|---|---|---|---|
| | Toner | maintenance | | Transfer | | charge | | stability | |
| | No. | rate (%) | | stability | | (μC/g) | | (μC/g) | |
| Example 1 | 1 | A | 98 | A | 0.01 | A | −33.0 | A | −0.5 |
| Example 2 | 2 | A | 97 | A | 0.01 | A | −32.5 | A | −0.5 |
| Example 3 | 3 | A | 96 | A | 0.01 | A | −31.0 | A | −0.5 |
| Example 4 | 4 | A | 95 | A | 0.02 | A | −31.5 | A | −0.5 |
| Example 5 | 5 | A | 94 | A | 0.03 | A | −30.5 | A | −0.7 |
| Example 6 | 6 | A | 93 | A | 0.02 | A | −32.0 | A | −1.5 |
| Example 7 | 7 | A | 92 | A | 0.03 | A | −30.3 | A | −1.0 |
| Example 8 | 8 | A | 91 | A | 0.04 | A | −32.5 | A | −1.7 |
| Example 9 | 9 | A | 91 | A | 0.04 | A | −30.1 | A | −1.1 |
| Example 10 | 10 | A | 90 | B | 0.06 | A | −30.1 | A | −1.2 |
| Example 11 | 11 | A | 91 | B | 0.05 | A | −30.1 | A | −1.9 |
| Example 12 | 12 | A | 90 | A | 0.04 | B | −29.8 | B | −2.0 |
| Example 13 | 13 | B | 89 | B | 0.07 | A | −30.1 | B | −2.3 |
| Example 14 | 14 | B | 89 | B | 0.06 | A | −30.3 | B | −2.5 |
| Example 15 | 15 | B | 84 | B | 0.07 | B | −29.6 | A | −1.6 |
| Example 16 | 16 | B | 88 | B | 0.06 | A | −31.0 | B | −3.4 |
| Example 17 | 17 | B | 83 | B | 0.08 | B | −29.1 | A | −1.8 |
| Example 18 | 18 | B | 82 | B | 0.07 | B | −28.0 | B | −2.2 |
| Example 19 | 19 | B | 81 | B | 0.09 | B | −28.1 | B | −2.2 |
| Example 20 | 20 | B | 85 | B | 0.08 | C | −27.4 | B | −2.4 |
| Example 21 | 21 | B | 85 | B | 0.09 | C | −26.0 | B | −3.0 |
| Example 22 | 22 | B | 80 | C | 0.10 | C | −22.8 | B | −3.3 |
| Comparative | 23 | D | 50 | C | 0.15 | D | −21.9 | B | −2.6 |
| Example 1 | | | | | | | | | |
| Comparative | 24 | D | 65 | D | 0.41 | D | −22.5 | B | −2.4 |
| Example 2 | | | | | | | | | |
| Comparative | 25 | D | 68 | D | 0.50 | C | −26.2 | D | −6.2 |
| Example 3 | | | | | | | | | |
| Comparative | 26 | D | 60 | D | 0.64 | D | −20.6 | C | −4.6 |
| Example 4 | | | | | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-189149, filed Nov. 28, 2022, which is hereby incorporated by reference herein in its entirety.

What is claimed is:

1. A toner comprising:
toner particles containing a binder resin; and
inorganic fine particles,
wherein the toner particles exhibit a peak derived from boric acid when subjected to attenuated total reflection infrared (ATR-IR) spectroscopy using germanium as an ATR crystal, and
wherein the inorganic fine particles include inorganic fine particles A made of a nitride of a group 13 element of the periodic table, and the inorganic fine particles A have a hexagonal crystal structure in X-ray diffraction analysis.

2. The toner according to claim 1, wherein the inorganic fine particles A have a number average primary particle size of 300 nm to 2000 nm, and the longer diameter D (nm) and thickness T (nm) of the individual inorganic fine particles A have a D/T ratio in the range of 3 to 55.

3. The toner according to claim 1, wherein the toner particles contain 0.1% to 10.0% by mass of boric acid.

4. The toner according to claim 1, wherein the proportion of the inorganic fine particles A is 0.01 part to 5.00 parts by mass relative to 100 parts by mass of the toner particles.

5. The toner according to claim 1, wherein the inorganic fine particles A are boron nitride particles or aluminum nitride particles.

6. The toner according to claim 5, wherein the boron nitride particles have a graphitization index GI of 1.60 to 35.0 when analyzed by powder X-ray diffractometry.

7. The toner according to claim 1, wherein the inorganic fine particles A contain 0.05% to 3.00% by mass of oxygen.

8. The toner according to claim 1, wherein when the toner is measured by an adhesion measurement method using a polycarbonate thin film, the amount of the inorganic fine particles A adhering to the thin film is 0.50 area % or less to 100 area % being the entire area of the polycarbonate thin film.

9. The toner according to claim 1, wherein when the toner is subjected to ATR-IR spectroscopy, a boric acid-derived peak with an intensity IB and a carbonyl group-derived peak with an intensity IC are detected, and the ratio IB/IC of IB to IC is in the range of 0.02 to 0.30.
